(19) United States
(12) Patent Application Publication
(10) Pub. No.: US 2017/0057448 A1
(43) Pub. Date: Mar. 2, 2017

(54) VEHICLE OCCUPANT SAFETY SYSTEM

(71) Applicant: Ford Global Technologies, LLC, Dearborn, MI (US)

(72) Inventors: Dean M. Jaradi, Macomb, MI (US); Iskander Farooq, Novi, MI (US); Mike James Whitens, Milford, MI (US); Mohammed Omar Faruque, Ann Arbor, MI (US)

(73) Assignee: FORD GLOBAL TECHNOLOGIES, LLC, Dearborn, MI (US)

(21) Appl. No.: 14/843,245

(22) Filed: Sep. 2, 2015

(51) Int. Cl. B60R 21/207; B60R 21/231

(52) U.S. Cl. CPC B60R 21/207; B60R 21/23138; B60R 2021/23146

(57) ABSTRACT

An occupant safety system includes an airbag module mountable to a vehicle seat frame. The airbag module includes a base and a retaining mechanism receivable by the frame. The base is attachable to the frame.

### BACKGROUND

Side impacts typically cause vehicle occupants to move laterally relative to the motion of a vehicle. Side airbag modules attached to vehicle seats can provide side airbags to receive occupants during an impact. However, side airbag modules require mounting brackets or mounting plates to attach to the vehicle seats, increasing weight of the vehicle and requiring difficult assembly procedures.

### BRIEF DESCRIPTION OF THE DRAWINGS

FIG. 1 is a view of an exemplary vehicle occupant safety system.

FIG. 2 is a view of the vehicle occupant safety system of FIG. 1 with an airbag module attached to a vehicle seat.

FIG. 3 is a view of one example of the passenger safety system of FIG. 1 in which the airbag module has sonic weld embossments.

FIG. 3A is a cross-sectional view of the seat illustrating the welding of the airbag module of FIG. 2 to a frame.

FIG. 4 is a view of another example of the passenger safety system of FIG. 1 in which the airbag module has an adhesive to attach to the vehicle seat.

FIG. 5 is a view of the airbag module of FIG. 2 including an airbag and an inflator.

### DETAILED DESCRIPTION

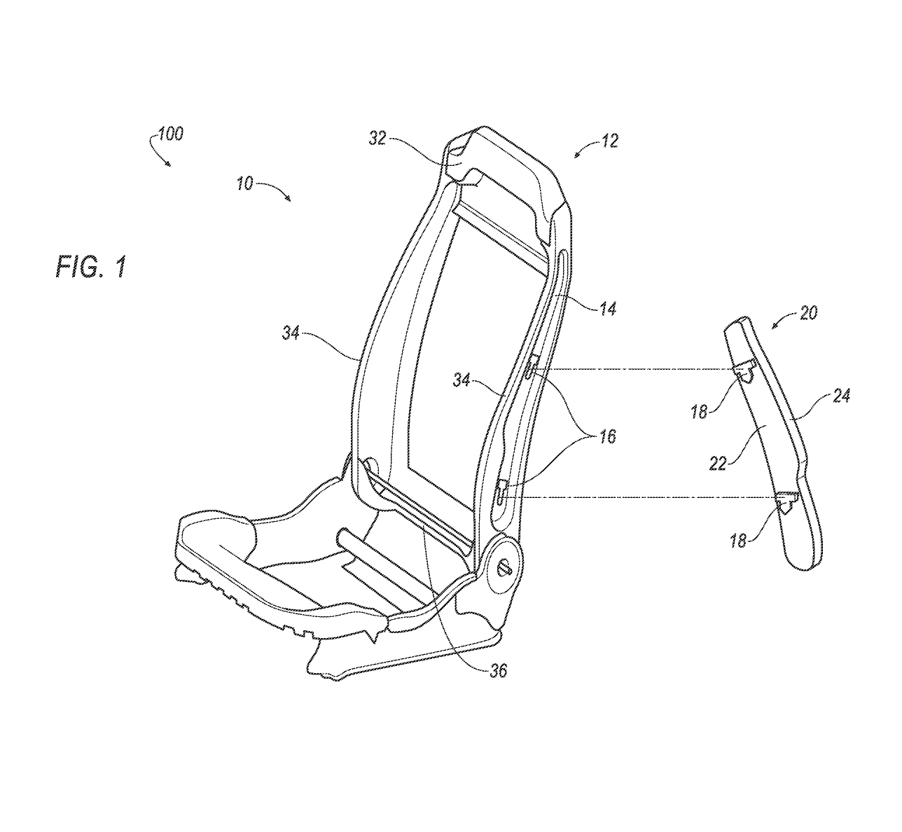

FIG. 1 illustrates an occupant safety system 10 in a vehicle 100. The occupant safety system 10 includes a seat 12. The seat 12 includes a frame 14 having a plurality of slots 16. The frame 14 may be constructed of a light-weight material, e.g., aluminum, carbon fiber, a polymer, etc. The slots 16 are configured to receive a tab 18 of an airbag module 20.

The frame 14 includes an upper subframe 32, a pair of side subframes 34, and a lower subframe 36. The upper subframe 32 can provide support to an upper body of an occupant, and the lower subframe 38 can provide support to a lower body of the occupant. The side subframes 34 connect the upper subframe 32 to the lower subframe 38.

The system 10 includes an airbag module 20 having at least one retaining mechanism 18, e.g. a tab. The tabs 18 are configured to fit into the slots 16 to hold the airbag module 20 in place against the frame 14. The module 20 includes a base 22 and a cover 24. The base 22 is in contact with the frame 14 when the module is being held in place against the frame 14, particularly contacting the side subframes 34, and may receive a retaining mechanism, e.g. the tabs 18, to secure the module 20 to the frame 14. The base may be constructed of any suitable material, e.g., a polymer, carbon fiber, etc.

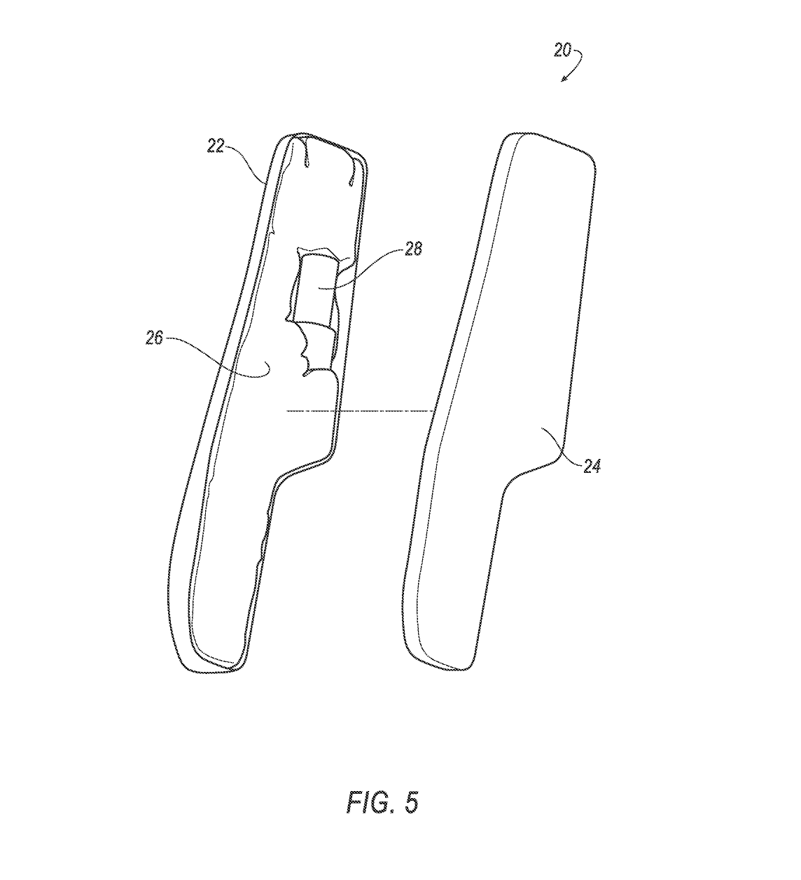

The cover 24 joins the base 22 to enclose an interior of the airbag module 20. For example, as seen in FIG. 5, the airbag module 20 includes an airbag 26 and an inflator 28 covered by the cover 24, and in the module 20 interior enclosed by the cover 24 and base 22, whereby the cover 24 in conjunction with the base 22 house the components of the airbag module 20. The module 20 may be a side airbag module including an airbag 26 provided to receive an occupant during an impact. Specifically, the module 20 is fixed to the side subframe 34, and configured to inflate the airbag 26 upon impact.

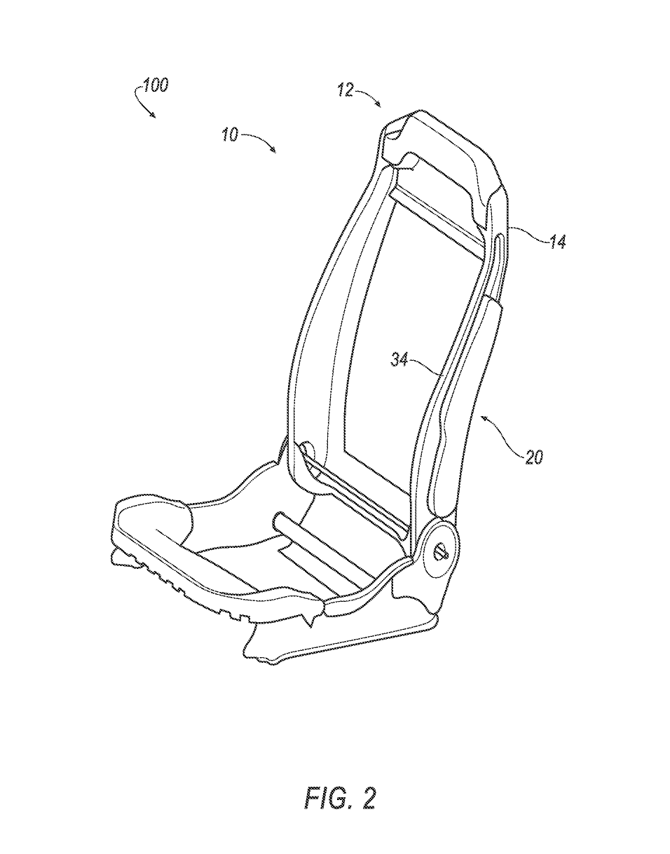

FIG. 2 illustrates the seat 12 with the module 20 attached directly to the frame 14, i.e., without a mounting bracket plate, bolts, weld nuts, or other devices to secure the module 20 to the frame 14. Specifically, the module 20 is affixed directly to the side subframe 34, i.e., without the use of a mounting plate. Attaching the module 20 directly to the frame 14 in the disclosed manner advantageously allows for a lighter construction than was previously possible, particularly if the frame 14 and/or the module 20 are constructed of a lightweight material, e.g., a polymer, carbon fiber, or aluminum. By removing the mounting bracket plate, bolts, weld nuts, etc., the overall weight is reduced and the profile of the seat 12 is reduced. The affixed module 20 further advantageously reduces the complexity of the vehicle 100 and simplifies the manufacturing process of the vehicle 100.

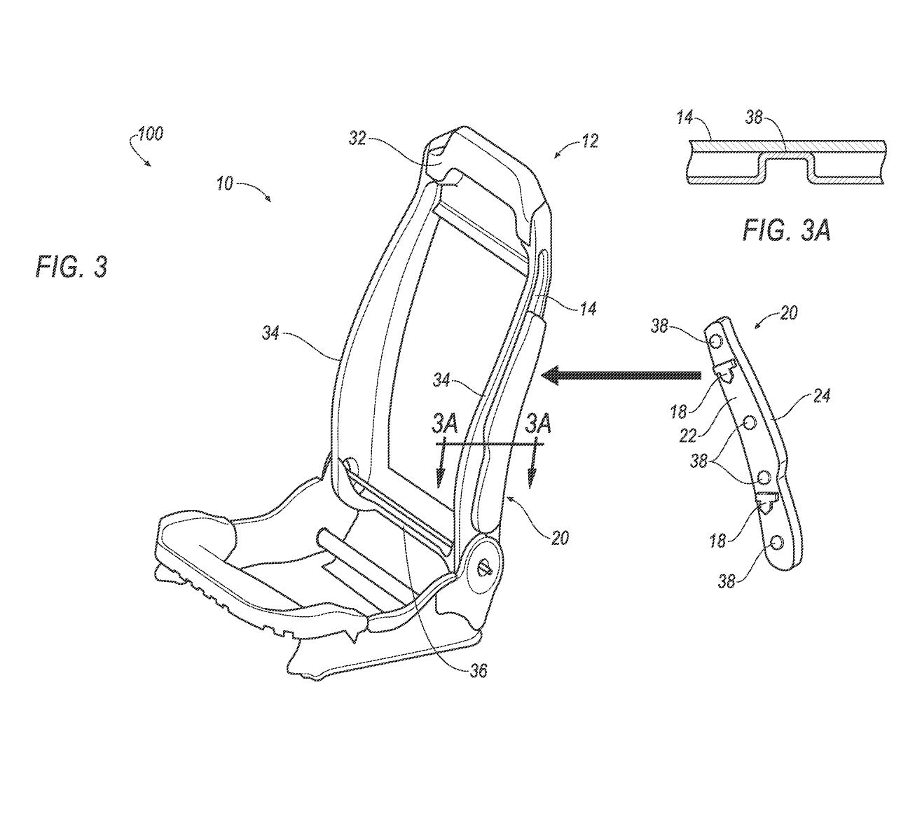

FIG. 3 illustrates the module 20 attached to the frame 14 with an ultrasonic weld. Here, the frame 14 is constructed of, e.g., a polymer or carbon fiber and the base 22 may be constructed of a similar polymer or carbon fiber. The frame 14 and the base 22 may be constructed of the same materials or of dissimilar materials. The base 22 includes a plurality of ultrasonic weld. embossments 38, i.e., protrusions from the base 22 that fuse with the frame 14 upon welding, that contact the frame 14, as shown in FIG. 3A. The tabs 18 fit into the slots 16, holding the base 22 in place with a friction fit while the embossments 38 are ultrasonically welded to the frame 14. The embossments 38 are then welded to the frame 14, fusing the module 20 to the frame 14, i.e., the base 22 is in direct contact with the frame 14. i.e., their respective surfaces at least partially touch each other. Specifically, the module 20 may be attached to one of the side subframes 34.

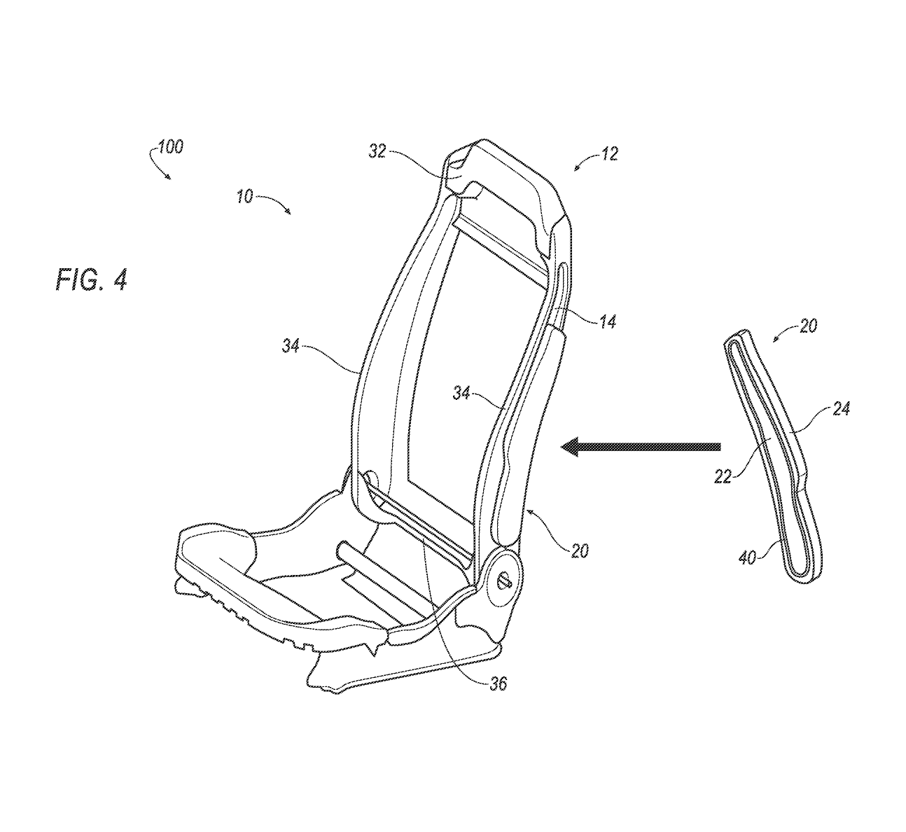

FIG. 4 illustrates the module 20 attached to the seat 12 with an adhesive. In this example, the frame 14 is constructed of metal, e.g. aluminum, while the base 22 may be constructed of a polymer or carbon fiber. Thus, the frame 14 and the base 22 are constructed of dissimilar materials, i.e., materials that are not the same, e.g. an aluminum frame 14 and a carbon fiber base 22. An adhesive 40 is applied to the base 22, which is then pressed directly to the frame 14. The adhesive 40 attaches the module 20 directly to the seat 12, i.e., the base 22 is in direct contact with the frame 14. The adhesive 40 may be, e.g., a water-based adhesive such as 3M Fast Tack 1000NF, or other commercially available epoxy or urethane based quick or thermal cure adhesives, such as Dow BETAMATE. Specifically, the module 20 may be attached to one of the side subframes 34,

FIG. 5 illustrates the module 20 in more detail. The base 2.2 houses the airbag 26 and the inflator 28. The airbag 26 is configured to be folded in the base 22 in an uninflated position. The airbag 26 may be constructed of any typical material, e.g., fabric, nylon, etc. The airbag 26 is arranged in a known manner to expand into the vehicle 100 and receive an occupant moving laterally, e.g., from a side impact.

The inflator 28 may of a known type, e.g., a cold-gas inflator, a pyrotechnic inflator, etc., and may be ultrasonically welded to the base 22. The inflator 28 is arranged to inflate the airbag 26 upon vehicle impact. The cover 24 is attached to the base 22 and covers the airbag 26 and the inflator 28. The cover 24 may include a seam (not shown) that directs the airbag 26 in a particular direction during inflation.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. An occupant safety system, comprising:
an airbag module including a base and a retaining mechanism receivable by the frame;
wherein the base is attachable to a vehicle seat frame with a weld.

2. The system of claim 1, wherein the retaining mechanism is a tab receivable by a slot on the frame.

3. The system of claim 1, wherein the airbag module is a side airbag module attachable to a side subframe of the frame.

4. The system of claim 1, wherein at least one of the seat frame and the base are constructed of at least one of carbon fiber and a polymer.

5. The system of claim 4, wherein the seat frame and the base are constructed of different materials.

6. The system of claim 1, wherein the airbag module further includes an inflator, the inflator attachable to the base with an ultrasonic weld.

7. The system of claim 1, wherein the airbag module further includes an airbag and a cover.

8. The system of claim 1, wherein the base includes at least one weld embossment, the embossment being fusable with the seat frame upon application of an ultrasonic weld.

9. A occupant safety system, comprising:
an airbag module including a base attachable to a vehicle seat frame with an adhesive and a retaining mechanism receivable by the seat frame.

10. The system of claim 9, wherein the retaining mechanism is a tab and the seat frame includes a slot, further wherein the tab is receivable in the slot.

11. The system of claim 9, wherein the airbag module is a side airbag module attachable to a side subframe of the seat frame.

12. The system of claim 9, wherein the frame is constructed of aluminum and the base is constructed of at least one of carbon fiber and a polymer. The system of claim 9, wherein the airbag module further includes an airbag and a cover.

14. A occupant safety system, comprising:
a vehicle seat frame including a pair of side subframes comprising an upper subframe, and a lower subframe; and
an airbag module including a base attachable to one of the side subframes;
wherein the airbag module touches the a first one of the side subframes.

15. The occupant safety system of claim 14, wherein the airbag module is attachable to the first side subframe with an ultrasonic weld.

16. The occupant safety system of claim 14, wherein the airbag module is attachable to the first side subframe with an adhesive.

17. The occupant safety system of claim 14, wherein the airbag module further includes an inflator, the inflator attachable to the base with an ultrasonic weld.

18. The occupant safety system of claim 14, wherein the base has a tab receivable into a slot in the first side subframe.

19. The occupant safety system of claim 14, wherein the side subframes and the base are constructed of different materials.

20. The occupant safety system of claim 14, wherein the airbag module further includes an airbag and a cover.
